(19) United States
(12) Patent Application Publication
(10) Pub. No.: US 2025/0219763 A1
(43) Pub. Date: Jul. 3, 2025

(54) ERROR MESSAGING FOR AMBIENT INTERNET OF THINGS (AIOT) DEVICES

(71) Applicant: Lenovo (United States) Inc., Morrisville, NC (US)

(72) Inventor: Hyung-Nam CHOI, Ottobrunn (DE)

(21) Appl. No.: 19/085,902

(22) Filed: Mar. 20, 2025

(51) Int. Cl. H04L 1/00; G16Y 40/20

(52) U.S. Cl. CPC H04L 1/0061; G16Y 40/20

(57) ABSTRACT

Various aspects of the present disclosure relate to error messaging during Internet of Things (IoT) operations. For example, an ambient IoT (AIoT) device may transmit messages to network nodes when errors occur during requested IoT operations. The AIoT device may transmit device to reader (D2R) messages that contain error information representative of the errors (or error types) during the IoT operation. Using the error information, a network node may perform actions to modify or update the requested IoT operation, such as by resending a message that contains updated or appropriate data for the IoT operation.

### TECHNICAL FIELD

The present disclosure relates to wireless communications, and more specifically to error messaging for ambient Internet of Things (AIoT) devices.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communications system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., 5G-advanced (5G-A), sixth generation (6G)).

Ambient power-enabled devices, such as AIoT devices, include battery-less devices that have limited storage capabilities (e.g., store a limited amount of energy using capacitors) or other capability restrictions. These ambient power-enabled devices may store energy by harvesting energy from the environment of the devices, such as via radio waves, light, heat, motion, and other energy/power sources available to the devices.

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The present disclosure relates to methods, apparatuses, and systems that perform error messaging for AIoT devices, such as during requested IoT operations (e.g., command and/or inventory procedures).

An IoT device for wireless communication is described. The IoT device may be configured to, capable of, or operable to perform one or more operations as described herein. For example, the IoT device may comprise at least one memory and at least one processor coupled with the at least one memory and configured to cause the IoT device to receive, from a network entity, a first message associated with an IoT operation and transmit a second message that includes error information associated with the IoT operation.

A processor for wireless communication is described. The processor may be configured to, capable of, or operable to perform one or more operations as described herein. For example, the processor may comprise at least one memory and at least one controller coupled with the at least one memory and configured to cause the processor to receive, from a network entity, a first message associated with an IoT operation and transmit a second message that includes error information associated with the IoT operation.

A method performed or performable by the IoT device is described. The method may comprise receiving, from a network entity, a first message associated with an IoT operation and transmitting a second message that includes error information associated with the IoT operation.

In some implementations of the IoT device, processor, and method described herein, the second message includes a medium access control (MAC) protocol data unit (PDU) that contains a defined error code indicating the error information.

In some implementations of the IoT device, processor, and method described herein, the defined error code represents an error associated with one or more capabilities of the IoT device.

In some implementations of the IoT device, processor, and method described herein, the defined error code represents an error associated with a power level of the IoT device that is insufficient with respect to the IoT device performing the IoT operation.

In some implementations of the IoT device, processor, and method described herein, the defined error code represents an error associated with a memory of the IoT device that is insufficient with respect to performing the IoT operation.

In some implementations of the IoT device, processor, and method described herein, the IoT device, processor, and method may further be configured to, capable of, performed, performable, or operable to transmit the second message after being enabled by a network entity.

In some implementations of the IoT device, processor, and method described herein, the IoT device is an AIoT device.

In some implementations of the IoT device, processor, and method described herein, the IoT operation is an inventory or command procedure.

In some implementations of the IoT device, processor, and method described herein, the network entity is a radio access network (RAN) node, and wherein the at least one processor is configured to cause the IoT device to transmit the second message to the RAN node.

In some implementations of the IoT device, processor, and method described herein, the network entity is an AIoT Function (AIOTF), and wherein the at least one processor is configured to cause the IoT device to transmit the second message to a RAN node associated with the AIOTF.

A network entity for wireless communication is described. The network entity may be configured to, capable of, or operable to perform one or more operations as described herein. For example, the network entity may comprise at least one memory and at least one processor coupled with the at least one memory and configured to cause the network entity to transmit a first message requesting performance of an IoT operation by an IoT device and receive a second message that includes error information associated with the IoT operation.

A method performed or performable by the network entity is described. The method may comprise transmitting a first message requesting performance of an IoT operation by an IoT device and receiving a second message that includes error information associated with the IoT operation.

In some implementations of the network entity and method described herein, the network entity and method may further be configured to, capable of, performed, performable, or operable to transmit a third message requesting performance of a modified IoT operation in response to receiving the second message.

In some implementations of the network entity and method described herein, the second message includes a MAC PDU that contains a defined error code indicating the error information.

In some implementations of the network entity and method described herein, the defined error code represents an error associated with one or more capabilities of the IoT device.

In some implementations of the network entity and method described herein, the defined error code represents an error associated with a power level of the IoT device that is insufficient with respect to the IoT device performing the IoT operation.

In some implementations of the network entity and method described herein, the defined error code represents an error associated with a memory of the IoT device that is insufficient with respect to performing the IoT operation.

In some implementations of the network entity and method described herein, the network entity is a RAN node.

In some implementations of the network entity and method described herein, the network entity is an AIOTF.

### BRIEF DESCRIPTION OF THE DRAWINGS

FIG. 1 illustrates an example of a wireless communications system in accordance with aspects of the present disclosure.

FIGS. 2A-2B illustrate example topologies for AIoT devices in accordance with aspects of the present disclosure.

FIG. 3A-3B illustrate example deployment scenarios for reader devices and AIoT devices in accordance with aspects of the present disclosure.

FIG. 4 illustrates an example MAC PDU structure in accordance with aspects of the present disclosure.

FIG. 5 illustrates a messaging flow for performing an IoT operation in accordance with aspects of the present disclosure.

FIG. 6 illustrates an example of a UE in accordance with aspects of the present disclosure.

FIG. 7 illustrates an example of a processor in accordance with aspects of the present disclosure.

FIG. 8 illustrates an example of a network equipment (NE) in accordance with aspects of the present disclosure.

FIG. 9 illustrates a flowchart of a method performed by a UE in accordance with aspects of the present disclosure.

FIG. 10 illustrates a flowchart of a method performed by an NE in accordance with aspects of the present disclosure.

### DETAILED DESCRIPTION

A wireless communications system may include one or more IoT devices, which may be an AIoT device, a passive-IoT device, and/or a passive radio frequency identification (RFID) tag (e.g., sticker, tag, badge, patch, or the like) that supports one or more functionalities at lower cost, complexity, and/or maintenance compared to other devices. For example, an AIoT device may harvest and store energy from an environment, such as one or more of solar (e.g., via photovoltaic energy harvesting), vibration (e.g., via piezoelectric, electrostatic, or electromagnetic energy harvesting), thermal (e.g., via thermoelectric energy harvesting), or radio waves, such as radio frequency (e.g., via signals received through an antenna of the AIoT device).

A RAN node, such as a UE or a base station (or other NEs), may operate as a reader device that interacts with one or more AIoT devices. For example, the RAN node, as the reader device, may transmit a carrier wave to an AIoT device to excite the AIoT device to perform backscattering transmissions or other communications, may message an AIoT device during device selection procedures, or may simply read or receive the backscattering transmissions. The RAN node may interact with various network functions, such as an AIoT function (AIOTF) that communicates directly with the RAN node and/or an application function (AF) that communicates with the RAN node via the AIOTF.

The AIoT device may perform one or more operations (e.g., transmission, reception, via backscattering) using the stored harvested energy. For example, the AIoT device may be a passive RFID tag equipped on an object or other device enabling for tracking of a location of the object or the other device using stored harvested energy. Example use cases or IoT operations (e.g., AIoT operations) performed by AIoT devices (e.g., one or multiple) include inventory taking and/or command procedures (e.g., read, write, control, enable, disable, and so on), sensor data collection, asset tracking, actuator control, and so on.

In some cases, issues or unforeseen errors may occur during running IoT operations and/or during commencement of an IoT operation for one or more AIoT devices. For example, an AIoT device may receive an AIoT message (e.g., a reader to device (R2D) message) that has unexpected or missing data. Currently, however, no mechanisms exist that support the AIoT device informing a requesting network node (e.g., a RAN node, AIOTF, AF, and so on) of the error or issue during the IoT operation. Instead, the requesting network node may repeatedly send messages to the AIoT device, leading to increased signaling and/or a failure of the requested IoT operation, among other drawbacks.

To overcome such issues, the technology described herein enables AIoT devices to transmit messages to network nodes when errors occur during requested IoT operations. For example, an AIoT device may transmit device to reader (D2R) messages that contain error information representative of the errors (or error types) during an IoT operation. Using the error information, the network node (e.g., the RAN node or AIOTF) may perform actions to modify or update the requested IoT operation, such as by resending message that contain updated or appropriate data (e.g., suitable data for the IoT operation). In doing so, the technology may prevent or mitigate increased signaling during IoT operations and/or operation failures, among other benefits.

Aspects of the present disclosure are described in the context of a wireless communications system.

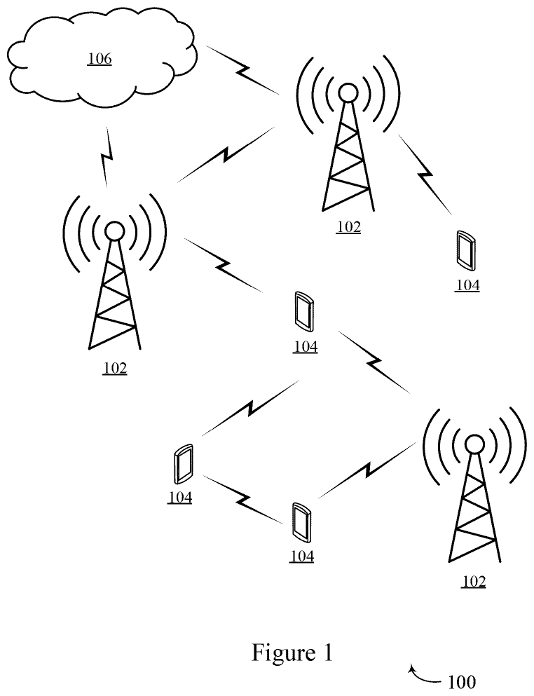

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be an NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management function (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signaling bearers, etc.) for the one or more UEs 104 served by the one or more NE 102 associated with the CN 106.

The CN 106 may communicate with a packet data network over one or more backhaul links (e.g., via an S1, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

The wireless communications system 100 may support managing (e.g., controlling, configuring) operation of IoT devices (e.g., which may be an example of a UE 104), such as AIoT devices. As described herein, an AIoT device may be associated with a low complexity profile (e.g., low power consumption, less capabilities) and/or be implemented as an ambient-power enabled ultra-low complexity device with ultra-low power consumption.

An AIoT device may be classified according to one or more categories. A first category AIoT device may lack both energy harvesting capabilities and communication capabilities. As such, the first category AIoT device may be exclusively capable of performing backscattering operations (e.g., backscattering transmissions). A second category AIoT device may support energy harvesting capabilities but lack communication capabilities. As such, the second category AIoT device may be exclusively capable of performing backscattering operations (e.g., backscattering transmissions). However, in some cases, because the second category AIoT device supports energy harvesting capabilities, the second category AIoT device may be capable of amplifying reflected signals using stored harvested energy. A third category AIoT device may support both energy harvesting and communication capabilities. In this example, the third category AIoT device may be equipped with an active radio frequency circuitry to support active communication (e.g., transmission, reception of signals).

In some embodiments, the wireless communications system 100 may implement various topologies and deployment scenarios, such as an example topology in which an NE (e.g., a base station or other network entity) functions as a reader (e.g., a reader device) and a source of a carrier wave (e.g., for exciting an AIoT device to perform backscattering), another example topology in which the NE functions as the reader and a different device (e.g., a UE) functions as the source of the carrier wave, another example topology in which the NE controls operations and the UE (e.g., the UE 104) or other network entities (e.g., nodes) function as readers and/or carrier wave sources, and the like.

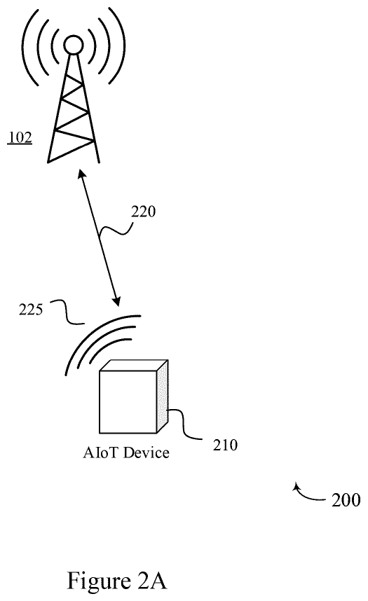

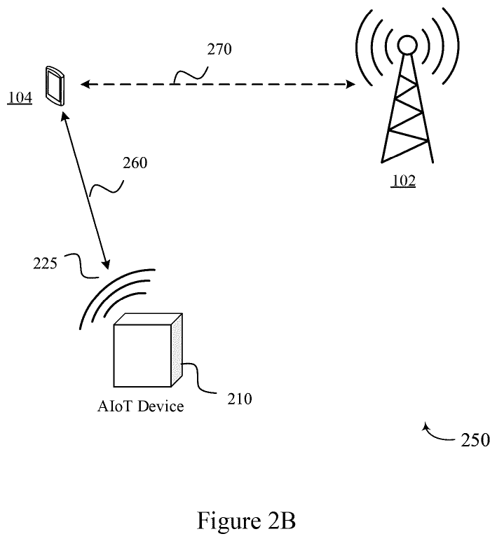

FIGS. 2A-2B illustrate example topologies for AIoT devices in accordance with aspects of the present disclosure. As shown in FIG. 2A, in a first topology 200, an AIoT device 210 directly and bidirectionally communicates with the NE 102 (e.g., which may serve a micro cell). A communication link 220 between the NE 102 and the AIoT device 210 may include AIoT data (e.g., via backscattering 225) and/or signaling. In an example implementation, both the AIoT device 210 and the NE 102 are located indoors (with the micro cell being part of a group of cells or NEs 102).

FIG. 2B illustrates a second topology 250, where the UE 104, or another node, acts as an intermediate node between the NE 102 and the AIoT device 210. For example, the UE 104 may function as an emitter and/or reader, where the UE 104 sends carrier waves to the AIoT device 210, which excite the AIoT device 210, enabling or causing the AIoT device 210 to performing the backscattering transmissions 225, which are read by the UE 104.

In the second topology 250, the AIoT device 210 directly and bidirectionally communicates with the UE 104 (e.g., which may relay data to the NE 102, serving a macro cell). A communication link 260 between the UE 104 and the AIoT device 210 and/or a link 270 between the UE 104 and the NE 102 may include AIoT data (e.g., via backscattering 225) and/or signaling. In an example implementation, the AIoT device 210 and the UE 104 are both located indoors, and the NE 102 is located outdoors (with the macro cell being part of a group of cells or NEs 102).

The AIoT device 210 may communicate with the intermediate node and/or the network (e.g., via the NE 102) using a reduced set of components. For example, the AIoT device 210 may be an IoT device of ultra-low complexity with ultra-low power consumption (e.g., sufficient for low-end IoT applications), having a radio protocol stack architecture that is comparatively compact with respect to typical NR architectures for communication devices.

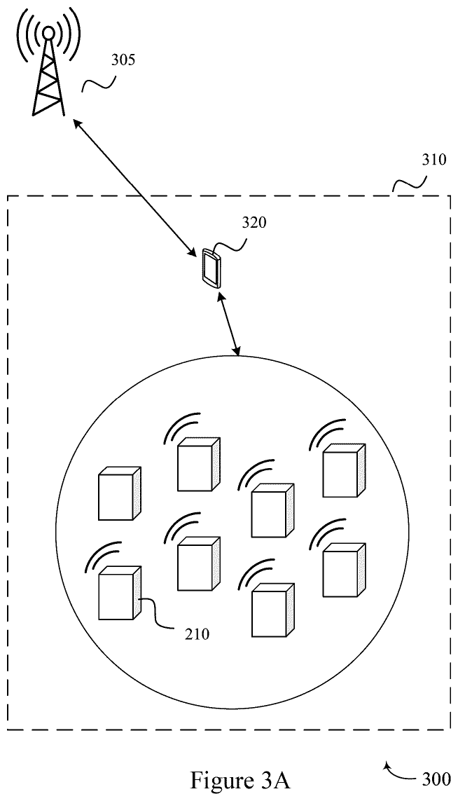

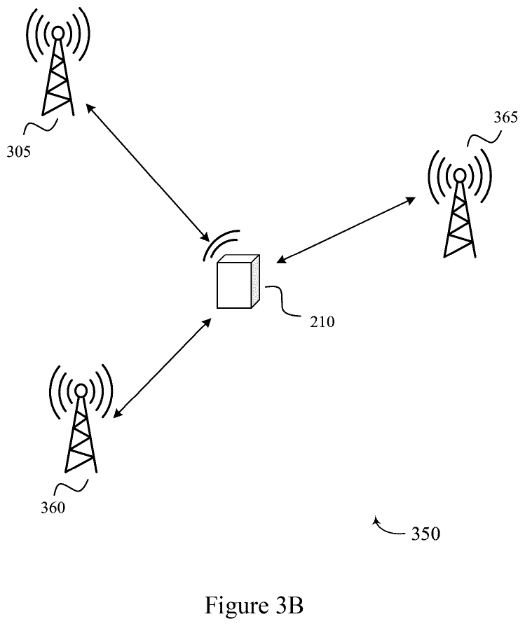

FIG. 3A illustrates an example deployment scenario 300 for a reader device and associated AIoT devices in accordance with aspects of the present disclosure. A location 310, or target area (e.g., a warehouse or other indoor facility), is served by a base station 305 in communication with (e.g., serving) a UE 320, or other RAN node, deployed and/or positioned as a reader device with respect to various AIoT devices 210 (e.g., 100 or more AIoT devices). The UE 320 may be a stationary reader device (e.g., a device fixed or installed to one location within the location 310), a mobile reader device (e.g., a device that moves within the location 310), and so on.

FIG. 3B illustrates another example deployment scenario 350 in accordance with aspects of the present disclosure. In the deployment scenario 350, a single AIoT device 210 is located in a service area or location that is served by three base stations 305, 360, 365, acting or operating as reader devices, of a RAN node (e.g., an AIoT RAN node).

As described herein, the wireless communications system 100 may support error messaging for AIoT devices, such as during IoT operations utilizing one or more AIoT devices. For example, when an error occurs in or at an AIoT device (e.g., the AIoT device 210) during an IoT operation, the AIoT device 210 may transmit a D2R message that contains error information associated with the error and/or occurrence of the error.

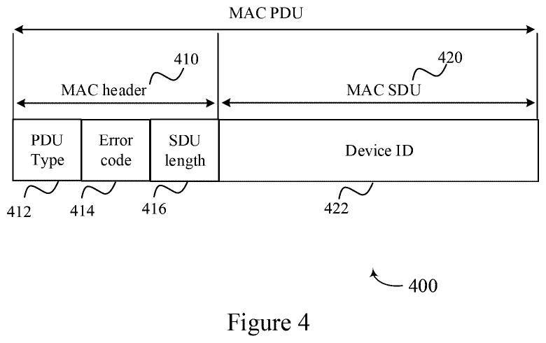

In some embodiments, the AIoT device transmits a MAC PDU that contains the error information. FIG. 4 illustrates an example MAC PDU 400 structure in accordance with aspects of the present disclosure. The MAC PDU 400 includes a header 410 and a service data unit (SDU) 420. The header 410 includes the following fields:

A PDU type field 412, which indicates the type of PDU. The PDU type field 412 may be encoded by L bits, and a predefined codepoint indicates that the MAC PDU 400 contains error information. For example, when the PDU type field 412 is encoded by 3 bits, the value “101” may indicate that the MAC PDU 400 contains error information;

An error code field 414, which indicates a code for an error that occurred at an AIoT device (e.g., the AIoT device 210) during an IoT operation. The error code field 414 may be encoded by M bits; and

An SDU length field 416, which indicates a length of the SDU 420. The SDU length field 416 may be encoded by N bits, where a length value is given in bytes.

The SDU 420 includes a device ID field 422, which may be of a variable size and indicates a device ID for the AIoT device 210. The device ID may be the unique permanent AIoT device ID or a temporary device ID (e.g., when configured by a RAN node or an AIOTF).

In some embodiments, the error code indicates or represents a defined error, where different error types may be defined. For example, an error code may indicate a protocol error, an error with regards to one or more device capabilities, and so on. Table 1 depicts various error codes (e.g., encoded in 4 bits) that may be defined for an IoT operation (e.g., an AIoT operation).

TABLE 1

| Error code | Error code name | Error description |
|---|---|---|
| 0000 | Unspecified | Used for all errors that are not covered by other error codes. |
| 0001 | Message header error | Used when an error in the message header is detected. |
| 0010 | Incorrect data value | Used when an incorrect data value is received. |
| 0011 | Duplicate detection | Used when a message is detected as a duplicate of a previously |
| | | received message. |
| 0100 | Not supported data | Used when a message contains data that is not supported, e.g., a |
| | | read-command to read data stored in the device's memory that do |
| | | not exist. |
| 0101 | Insufficient memory | Used when data are received and to be written into the device's |
| | | memory, but the size of the data exceeds the supported memory |
| | | size. |
| 0110 | Insufficient power | Used when an operation cannot be executed due to insufficient |
| | | power at the device |
| 0111 | Insufficient processing | Used when an operation cannot be executed due to insufficient |
| | capability | processing capability at the device |
| 1000 | Reserved for future use | |
| . . . | | |
| 1111 | Reserved for future use | |

A RAN node, AIOTF, or other network node may receive the error information from the AIoT device 210. For example, the AIOTF may receive the error information directly from the AIoT device 210 and/or from the RAN node (e.g., base station 305) acting as a reader device for the AIoT device 210. Using the received error information, the network node may take or perform one or more actions, based on the type of error indicated by the error information (e.g., denoted by an error code in the error code field 414 of the MAC PDU 400).

In some cases, the network node may configure or otherwise enable the AIoT device 210 to transmit the error information. For example, the network node may transmit an AIoT message (e.g., R2D message), before or during an IoT operation, which includes a field that indicates whether error messaging is enabled or available for the AIoT device and/or current or future IoT operations.

As described herein, the technology, in some embodiments, may be implemented as one or more messaging flows between the AIoT device 210, a reader device (e.g., a RAN node, such as the base station 305) and a network function (e.g., an AIOTF and/or AF).

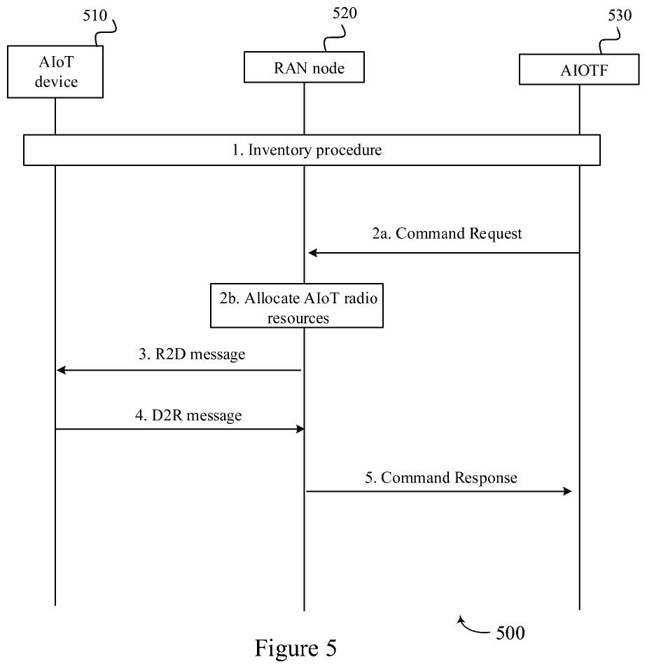

FIG. 5 illustrates a messaging flow 500 for performing an IoT operation in accordance with aspects of the present disclosure. The messaging flow 500 may implement various aspects of the present disclosure described herein. For example, the messaging flow 500 may include an AIoT device 510, a RAN node 520, and an AIOTF 530, which may be examples of AIoT devices, RAN nodes, and AIOTFs as described herein. In the following description of the messaging flow 500, the operations between the AIoT device 510, the RAN node 520, and the AIOTF 530 may be performed in different orders or at different times. Some operations may also be omitted, or other operations may be added. Although the AIoT device 510, the RAN node 520, and the AIOTF 530 are shown performing the operations of the messaging flow 500, some aspects of some operations may also be performed by other entities of the messaging flow 500 or by entities that are not shown in the messaging flow 500, or any combination thereof.

The messaging flow 500 may be performed, for example, under the deployment scenario 350 depicted in FIG. 3B, where the RAN node 520 includes three base stations (e.g., base stations 305, 360, 365) are reader devices for the AIoT device 510. Further, the AIOTF 530 communicates directly with the RAN node 520 to perform IoT operations, such as an inventory or command procedure. For example, the AIOTF 530 requests that data having a size of 256 bytes is to be written into the memory of the AIoT device 510 (e.g., without knowledge of the memory size, or available memory size, at the AIoT device 510).

In step 1, the AIoT device 510, the RAN node 520, and the AIOTF 530 perform the requested inventory procedure. For example, the RAN node 520 uses one of the serving base stations (e.g., base station 305) as the reader device for the inventory procedure at the AIoT device 510.

In step 2a, the AIOTF 530 send a command request message to the RAN node 520. The command request message contains data to be written into the memory of the AIoT device 510.

In step 2b, the AIoT RAN node 520 allocates AIoT radio resources. For example, the RAN node 520 selects a base station (e.g., the base station 305) as a reader device for the command procedure with the AIoT device 510.

In step 3, the RAN node 520 sends an R2D message to the AIoT device 510. For example, the RAN node 520, via the selected reader device, transmits the R2D message to the AIoT device 510. The R2D message contains the data to be written into the memory of the AIoT device 510.

In step 4, the AIoT device 510 sends a D2R message back to the RAN node 520. For example, the AIoT device 510, supporting a memory size of 64 bytes, determines that the received data cannot be written into its memory. Based on the determination, the AIoT device 510 sends a D2R message with a MAC PDU (e.g., the MAC PDU 400) containing the error code “0101” to indicate that the AIoT device 510 has insufficient memory to execute the requested write-command (e.g., having a size of 256 bytes).

In step 5, the RAN node 520 sends a command response message to the AIOTF 530. For example, the RAN node 520 sends a command response that includes the error information received from the AIoT device 510.

Based on the received error information, the AIOTF 530 may initiate a new write-command procedure for the AIoT device 510 at a later point of time, such as a write-command having a size that is suitable for the memory of the AIoT device 510.

In some embodiments, the RAN node 520 may receive additional command request messages from the AIOTF 530 during a running or ongoing IoT operation (e.g., an ongoing command or inventory procedure). For example, the AIOTF 530 sends a request to retrieve location information from the AIoT device 510. The RAN node 520, in response to the command message, selects another reader device (e.g., the base station 360) for the new command procedure.

During the new command procedure and similar to the messaging flow 500, the RAN node 520 transmits an R2D message to the AIoT device 510. The R2D message includes a request (e.g., read-command) to transmit the location information that is stored in the AIoT device 510. However, the AIoT device 510 has a limited processing capability and cannot execute the read-command. Therefore, in response to receiving the read-command, the AIoT device 510 sends a D2R message with the MAC PDU 400 containing the error code “0111” to indicate that the AIoT device 510 has an insufficient processing capability to execute the requested read-command.

The RAN node 520 may then send a command response message to the AIOTF 530 that includes the error information. Using the information, the AIOTF 530 may initiate the command procedure at a later time (e.g., after the ongoing command procedure ends), in order for the AIoT device 510 to apply its limited processing capabilities solely to the read-command.

While the messaging flow 500 depicts the AIoT device 510 transmitting error information to the RAN node 520 (e.g., via D2R messages), the AIoT device 510, in some cases, may transmit the error information directly to the AIOTF 530. For example, while the AIoT device 510 includes a compact protocol stack, the AIoT device 510 may include layers that facilitate communications with the RAN node 520, the AIOTF 530, and/or other application functions (AFs).

These layers include an AIoT data layer configured to transmit information between the AIoT device 510 and an AF, an AIoT non-access stratum (NAS) layer configured to transmit information between the AIoT device 510 and the AIOTF 530 (e.g., information during an inventory or command procedure, such as the error information), and an access stratum (AS) layer configured to transmit information between the AIoT device 510 and the RAN node 520.

Thus, in various embodiments, an AIoT device (e.g., the AIoT device 210 or 510) may be configured to transmit error information during IoT operations (e.g., AIoT operations), such as error information representing errors or problems for a current IoT operation. In doing so, the network nodes initiating the IoT operations may be informed of the errors and respond by adjusting the IoT operations, such as write-commands, read-commands, or other requests to be served by the AIoT device, among other benefits.

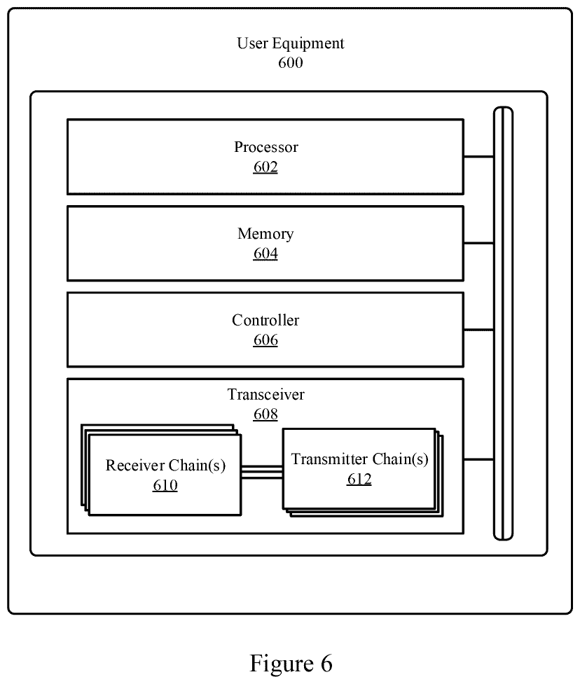

FIG. 6 illustrates an example of a UE 600 in accordance with aspects of the present disclosure. The UE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the UE 600 to perform various functions of the present disclosure.

The memory 604 may include volatile or non-volatile memory. The memory 604 may store computer-readable, computer-executable code including instructions when executed by the processor 602 cause the UE 600 to perform various functions described herein. The code may be stored in a non-transitory computer-readable medium such the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the UE 600 to perform one or more of the functions described herein (e.g., executing, by the processor 602, instructions stored in the memory 604). For example, the processor 602 may support wireless communication at the UE 600 in accordance with examples as disclosed herein. The UE 600 (e.g., as an AIoT device) may be configured to support a means for receiving, from a network entity, a first message associated with an IoT operation and transmitting a second message that includes error information associated with the IoT operation.

The controller 606 may manage input and output signals for the UE 600. The controller 606 may also manage peripherals not integrated into the UE 600. In some implementations, the controller 606 may utilize an operating system such as iOS®, ANDROID®, WINDOWS®, or other operating systems. In some implementations, the controller 606 may be implemented as part of the processor 602.

In some implementations, the UE 600 may include at least one transceiver 608. In some other implementations, the UE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas for receive the signal over the air or wireless medium. The receiver chain 610 may include at least one amplifier (e.g., a low-noise amplifier (LNA)) configured to amplify the received signal. The receiver chain 610 may include at least one demodulator configured to demodulate the receive signal and obtain the transmitted data by reversing the modulation technique applied during transmission of the signal. The receiver chain 610 may include at least one decoder for decoding the processing the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

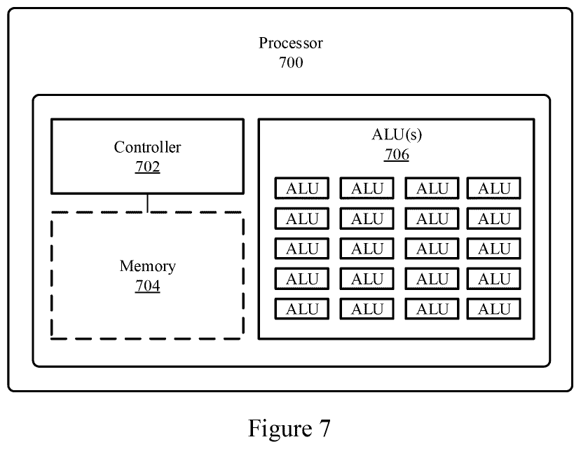

FIG. 7 illustrates an example of a processor 700 in accordance with aspects of the present disclosure. The processor 700 may be an example of a processor configured to perform various operations in accordance with examples as described herein. The processor 700 may include a controller 702 configured to perform various operations in accordance with examples as described herein. The processor 700 may optionally include at least one memory 704, which may be, for example, an L1/L2/L3 cache. Additionally, or alternatively, the processor 700 may optionally include one or more arithmetic-logic units (ALUs) 706. One or more of these components may be in electronic communication or otherwise coupled (e.g., operatively, communicatively, functionally, electronically, electrically) via one or more interfaces (e.g., buses).

The processor 700 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 700) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 702 may be configured to manage and coordinate various operations (e.g., signaling, receiving, obtaining, retrieving, transmitting, outputting, forwarding, storing, determining, identifying, accessing, writing, reading) of the processor 700 to cause the processor 700 to support various operations in accordance with examples as described herein. For example, the controller 702 may operate as a control unit of the processor 700, generating control signals that manage the operation of various components of the processor 700. These control signals include enabling or disabling functional units, selecting data paths, initiating memory access, and coordinating timing of operations.

The controller 702 may be configured to fetch (e.g., obtain, retrieve, receive) instructions from the memory 704 and determine subsequent instruction(s) to be executed to cause the processor 700 to support various operations in accordance with examples as described herein. The controller 702 may be configured to track memory address of instructions associated with the memory 704. The controller 702 may be configured to decode instructions to determine the operation to be performed and the operands involved. For example, the controller 702 may be configured to interpret the instruction and determine control signals to be output to other components of the processor 700 to cause the processor 700 to support various operations in accordance with examples as described herein. Additionally, or alternatively, the controller 702 may be configured to manage flow of data within the processor 700. The controller 702 may be configured to control transfer of data between registers, arithmetic logic units (ALUs), and other functional units of the processor 700.

The memory 704 may include one or more caches (e.g., memory local to or included in the processor 700 or other memory, such RAM, ROM, DRAM, SDRAM, SRAM, MRAM, flash memory, etc. In some implementations, the memory 704 may reside within or on a processor chipset (e.g., local to the processor 700). In some other implementations, the memory 704 may reside external to the processor chipset (e.g., remote to the processor 700).

The memory 704 may store computer-readable, computer-executable code including instructions that, when executed by the processor 700, cause the processor 700 to perform various functions described herein. The code may be stored in a non-transitory computer-readable medium such as system memory or another type of memory. The controller 702 and/or the processor 700 may be configured to execute computer-readable instructions stored in the memory 704 to cause the processor 700 to perform various functions. For example, the processor 700 and/or the controller 702 may be coupled with or to the memory 704, the processor 700, the controller 702, and the memory 704 may be configured to perform various functions described herein. In some examples, the processor 700 may include multiple processors and the memory 704 may include multiple memories. One or more of the multiple processors may be coupled with one or more of the multiple memories, which may, individually or collectively, be configured to perform various functions herein.

The one or more ALUs 706 may be configured to support various operations in accordance with examples as described herein. In some implementations, the one or more ALUs 706 may reside within or on a processor chipset (e.g., the processor 700). In some other implementations, the one or more ALUs 706 may reside external to the processor chipset (e.g., the processor 700). One or more ALUs 706 may perform one or more computations such as addition, subtraction, multiplication, and division on data. For example, one or more ALUs 706 may receive input operands and an operation code, which determines an operation to be executed. One or more ALUs 706 be configured with a variety of logical and arithmetic circuits, including adders, subtractors, shifters, and logic gates, to process and manipulate the data according to the operation. Additionally, or alternatively, the one or more ALUs 706 may support logical operations such as AND, OR, exclusive-OR (XOR), not-OR (NOR), and not-AND (NAND), enabling the one or more ALUs 706 to handle conditional operations, comparisons, and bitwise operations.

The processor 700 may support wireless communication in accordance with examples as disclosed herein. The UE processor 700 may be configured to support a means for receiving, from a network entity, a first message associated with an IoT operation and transmitting a second message that includes error information associated with the IoT operation.

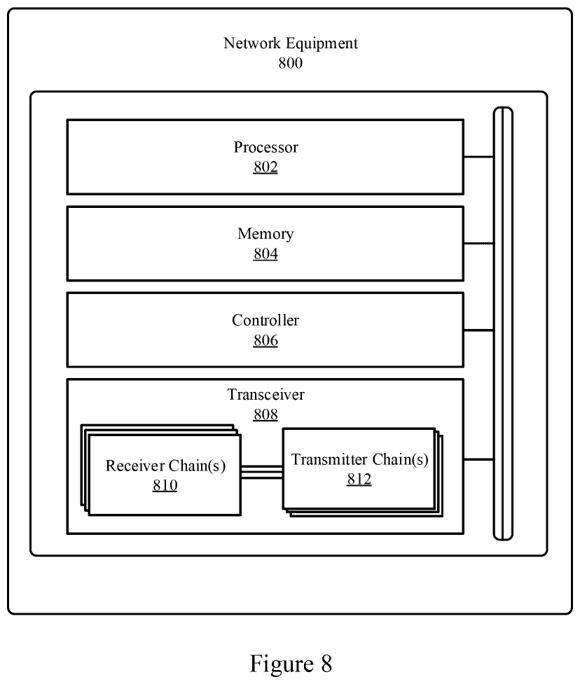

FIG. 8 illustrates an example of an NE 800 in accordance with aspects of the present disclosure. The NE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the NE 800 to perform various functions of the present disclosure.

The memory 804 may include volatile or non-volatile memory. The memory 804 may store computer-readable, computer-executable code including instructions when executed by the processor 802 cause the NE 800 to perform various functions described herein. The code may be stored in a non-transitory computer-readable medium such the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the NE 800 to perform one or more of the functions described herein (e.g., executing, by the processor 802, instructions stored in the memory 804). For example, the processor 802 may support wireless communication at the NE 800 in accordance with examples as disclosed herein. The NE 800, as part of a RAN node, may be configured to support a means for transmitting a first message requesting performance of an IoT operation by an IoT device and receiving a second message that includes error information associated with the IoT operation.

The controller 806 may manage input and output signals for the NE 800. The controller 806 may also manage peripherals not integrated into the NE 800. In some implementations, the controller 806 may utilize an operating system such as iOS®, ANDROID®, WINDOWS®, or other operating systems. In some implementations, the controller 806 may be implemented as part of the processor 802.

In some implementations, the NE 800 may include at least one transceiver 808. In some other implementations, the NE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas for receive the signal over the air or wireless medium. The receiver chain 810 may include at least one amplifier (e.g., a low-noise amplifier (LNA)) configured to amplify the received signal. The receiver chain 810 may include at least one demodulator configured to demodulate the receive signal and obtain the transmitted data by reversing the modulation technique applied during transmission of the signal. The receiver chain 810 may include at least one decoder for decoding the processing the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

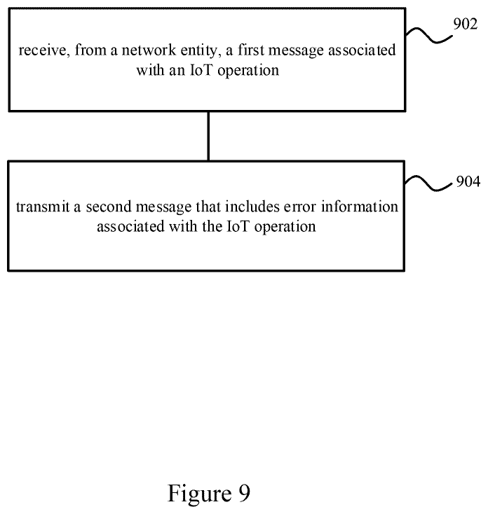

FIG. 9 illustrates a flowchart of a method in accordance with aspects of the present disclosure. The operations of the method may be implemented by a UE (e.g., an AIoT device) as described herein. In some implementations, the UE may execute a set of instructions to control the function elements of the UE to perform the described functions.

At 902, the method may include receiving, from a network entity, a first message associated with an IoT operation. The operations of 902 may be performed in accordance with examples as described herein. In some implementations, aspects of the operations of 902 may be performed by a UE as described with reference to FIG. 6.

At 904, the method may include transmitting a second message that includes error information associated with the IoT operation. The operations of 904 may be performed in accordance with examples as described herein. In some implementations, aspects of the operations of 904 may be performed by a UE as described with reference to FIG. 6.

It should be noted that the method described herein describes a possible implementation, and that the operations and the steps may be rearranged or otherwise modified and that other implementations are possible.

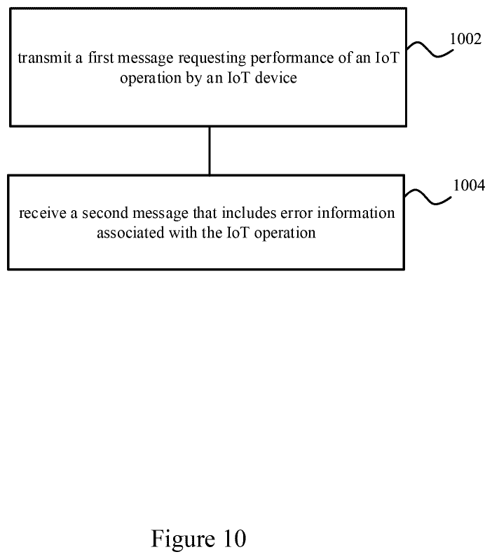

FIG. 10 illustrates a flowchart of a method in accordance with aspects of the present disclosure. The operations of the method may be implemented by an NE (e.g., operating as a network function) as described herein. In some implementations, the NE may execute a set of instructions to control the function elements of the NE to perform the described functions.

At 1002, the method may include transmitting a first message requesting performance of an IoT operation by an IoT device. The operations of 1002 may be performed in accordance with examples as described herein. In some implementations, aspects of the operations of 1002 may be performed by an NE as described with reference to FIG. 8.

At 1004, the method may include receiving a second message that includes error information associated with the IoT operation. The operations of 1004 may be performed in accordance with examples as described herein. In some implementations, aspects of the operations of 1004 may be performed by an NE as described with reference to FIG. 8.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An Internet of Things (IoT) device for wireless communication, comprising:
at least one memory; and
at least one processor coupled with the at least one memory and configured to cause the IoT device to:
receive, from a network entity, a first message associated with an IoT operation; and
transmit a second message that includes error information associated with the IoT operation.

2. The IoT device of claim 1, wherein the second message includes a medium access control (MAC) protocol data unit (PDU) that contains a defined error code indicating the error information.

3. The IoT device of claim 2, wherein the defined error code represents an error associated with one or more capabilities of the IoT device.

4. The IoT device of claim 2, wherein the defined error code represents an error associated with a power level of the IoT device that is insufficient with respect to the IoT device performing the IoT operation.

5. The IoT device of claim 2, wherein the defined error code represents an error associated with a memory of the IoT device that is insufficient with respect to performing the IoT operation.

6. The IoT device of claim 1, wherein the at least one processor is configured to cause the IoT device to transmit the second message after being enabled by a network entity.

7. The IoT device of claim 1, wherein the IoT device is an ambient IoT (AIoT) device.

8. The IoT device of claim 1, wherein the IoT operation is an inventory or command procedure.

9. The IoT device of claim 1, wherein the network entity is a radio access network (RAN) node, and wherein the at least one processor is configured to cause the IoT device to transmit the second message to the RAN node.

10. The IoT device of claim 1, wherein the network entity is an AIoT Function (AIOTF), and wherein the at least one processor is configured to cause the IoT device to transmit the second message to a radio access network (RAN) node associated with the AIOTF.

11. A network entity for wireless communication, comprising:
at least one memory; and
at least one processor coupled with the at least one memory and configured to cause the network entity to:
transmit a first message requesting performance of an Internet of Things (IoT) operation by an IoT device; and
receive a second message that includes error information associated with the IoT operation.

12. The network entity of claim 11, wherein the at least one processor is further configured to cause the network entity to:
transmit a third message requesting performance of a modified IoT operation in response to receiving the second message.

13. The network entity of claim 11, wherein the second message includes a medium access control (MAC) protocol data unit (PDU) that contains a defined error code indicating the error information.

14. The network entity of claim 13, wherein the defined error code represents an error associated with one or more capabilities of the IoT device.

15. The network entity of claim 13, wherein the defined error code represents an error associated with a power level of the IoT device that is insufficient with respect to the IoT device performing the IoT operation.

16. The network entity of claim 13, wherein the defined error code represents an error associated with a memory of the IoT device that is insufficient with respect to performing the IoT operation.

17. The network entity of claim 11, wherein the network entity is a radio access network (RAN) node.

18. The network entity of claim 11, wherein the network entity is an ambient IoT function (AIOTF).

19. A method performed by an Internet of Things (IoT) device, the method comprising:
receiving, from a network entity, a first message associated with an IoT operation; and
transmitting a second message that includes error information associated with the IoT operation.

20. A method performed by a network entity, the method comprising:
transmitting a first message requesting performance of an Internet of Things (IoT) operation by an IoT device; and
receiving a second message that includes error information associated with the IoT operation.
